(19) United States
(12) Patent Application Publication
(10) Pub. No.: US 2008/0041777 A1
(43) Pub. Date: Feb. 21, 2008

(54) Filter device having filter member easily changing structure

(76) Inventor: Chun-Hsien Lee, Kaoshiung Hsien (TW)

Correspondence Address: CHARLES E. BAXLEY, ESQ., 90 JOHN STREET, THIRD FLOOR, NEW YORK, NY, 10038, US

(21) Appl. No.: 11/505,158

(22) Filed: Aug. 15, 2006

(51) Int. Cl. B01D 35/30

(52) U.S. Cl. 210/232

(57) ABSTRACT

A filter device includes a container, a carrier pivotally attached to an upper portion of the container for allowing the carrier to be rotated and moved toward and away from the container, the carrier includes one or more sockets for detachably coupling one or more cartridges to the sockets. The carrier 20 and the cartridges 30 may be rotated away from the container 10 for allowing the cartridges 30 to be easily held and rotated relative to the carrier by the user, and for allowing the filter members to be easily engaged into or disengaged from the cartridges or to be changed or replaced with the other new filter members. The container includes a platform for forming a stable base structure to the container.

### BACKGROUND OF THE INVENTION

1. Field of the Invention

The present invention relates to a filter device, and more particularly to a filter device including a structure for allowing the filter members to be changed or replaced with the new filter members.

2. Description of the Prior Art

Typical filter devices or assemblies comprise a carrier, and two or more cartridges detachably attached or threaded to the carrier and each for receiving or carrying or supporting a filter member therein, such as an impurity filter member, a sediment filter member, etc., and one or more canisters also detachably attached or threaded to the carrier and each for receiving or carrying or supporting another filter member therein, such as a reverse osmosis filter member, an ultrafiltration filter member, etc.

For example, U.S. Pat. No. 5,282,972 to Hanna et al. discloses one of the typical waste water recycling methods also comprising two or more cartridges detachably attached or threaded to the carrier for receiving filter members therein, and one or more canisters also detachably attached or threaded to the carrier for receiving the other filter members therein.

However, the carrier is normally solidly attached or secured onto a supporting wall or solidly secured and received within a cabinet or a chest or contained within a tiny space such that the cartridges and/or the canisters may not be easily attached or threaded to the carrier and also may not be easily detached or disengaged from the carrier.

U.S. Pat. No. 5,482,619 to Chow discloses another typical water filter assembly also comprising two or more cartridges detachably attached or threaded to the carrier for receiving filter members therein, and one or more canisters also detachably attached or threaded to the carrier for receiving the other filter members therein.

However, the carrier is solidly attached or secured onto a supporting plate which will then be attached or secured onto a supporting wall or solidly secured and received within a cabinet or a chest or contained within a tiny space such that the cartridges and/or the canisters also may not be easily attached or threaded to the carrier and also may not be easily detached or disengaged from the carrier.

U.S. Pat. No. 6,294,089 to Yeh discloses a further typical dyna-mag activator also comprising two or more canisters detachably attached or threaded to the carrier for receiving filter members therein, and one or more cylindrical housings also detachably attached or threaded to the carrier for receiving the other fine filter members therein.

However, the carrier is also required to be solidly attached or secured onto a supporting wall or solidly secured and received within a cabinet or a chest or contained within a tiny space such that the canisters and/or the cylindrical housings also may not be easily attached or threaded to the carrier and also may not be easily detached or disengaged from the carrier.

The present invention has arisen to mitigate and/or obviate the afore-described disadvantages of the conventional filter member attaching structures for the filter devices.

### SUMMARY OF THE INVENTION

The primary objective of the present invention is to provide a filter device including a structure for allowing the filter members to be changed or replaced with the new filter members.

In accordance with one aspect of the invention, there is provided a filter device comprising a container including an upper portion and a lower portion, a carrier pivotally attached to the upper portion of the container for allowing the carrier to be rotated and moved toward and away from the container, the carrier including at least one socket provided thereon, and at least one cartridge detachably coupled to the socket of the carrier for detachably coupling the cartridge to the carrier.

The cartridge includes a threaded coupling provided thereon for coupling to the socket of the carrier. The cartridge includes a filter member disposed therein. The carrier is pivotally attached to the upper portion of the container with a pivot axle.

The container includes at least one notch formed in the upper portion thereof, and the carrier includes at least one ear extended therefrom and engaged into the notch of the container, and the pivot axle is engaged into the notch of the container and engaged through the ear of the carrier for pivotally coupling the carrier to the container.

The container includes a passage formed therein and communicating with the notch of the container for receiving the pivot axle in the passage of the container. The container includes at least one end caps engaged into one end portion of the passage for enclosing the passage of the container and for retaining the pivot axle within the passage of the container.

The container includes a platform extended from the lower portion of the container for forming an open space above the platform and between the platform and the container and for forming a stable base structure to the container.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a filter device in accordance with the present invention;

FIG. 2 is a front plan schematic view of the filter device;

FIG. 3 is a side plan schematic view of the filter device;

FIG. 4 is a top plan schematic view of the filter device;

FIG. 5 is a side plan schematic view similar to FIG. 3, illustrating the operation of the filter device; and

FIG. 6 is a also side plan schematic view similar to FIGS. 3 and 5, illustrating the operation of the filter device.

### DETAILED DESCRIPTION OF THE PREFERRED EMBODIMENT

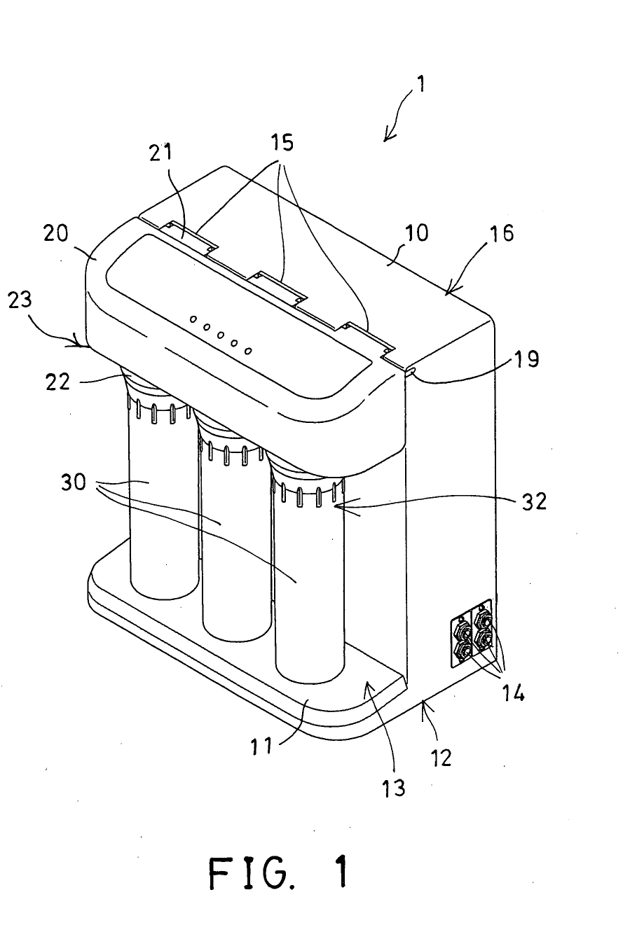

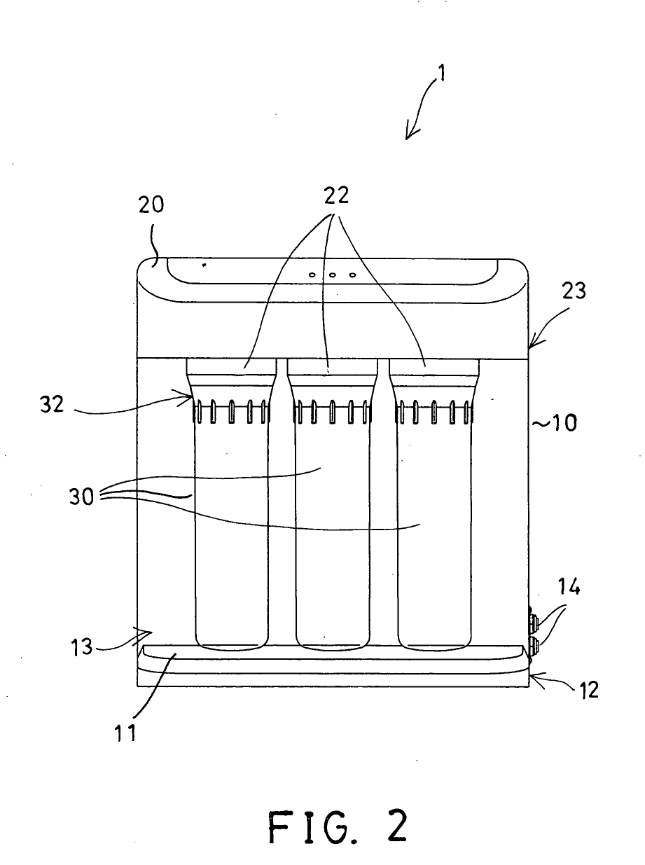

Referring to the drawings, and initially to FIGS. 1-4, a filter device 1 in accordance with the present invention comprises a housing or container 10 for receiving or containing such as water, control devices and/or filter elements (not shown) therein which is not related to the present invention and will not be described in further details, and the container 10 includes a base or platform 11 extended forwardly from the lower or bottom portion 12 of the container 10 for forming or defining an open space 13 above the platform 11 or between the platform 11 and the container 10 and also for increasing the lower area of the container 10 to allow the container 10 to be stably supported on the table or the other supporting surfaces or for forming a stable base structure to the container 10.

The container 10 includes one or more coupling ports 14 provided or attached to one side portion or the lower or bottom portion 12 thereof for coupling to such as a water reservoir or the like. The container 10 further includes one or more notches 15 formed in the upper portion 16 thereof, such as formed in the upper and front portion 16 thereof, and includes a passage 17 (FIG. 4) also formed in the upper and front portion 16 thereof and intersecting or communicating with the notches 15 of the container 10 for receiving a pivot axle 18 in the passage 17 of the container 10, and includes one or two end caps 19 engaged into the one or two outer end portions of the passage 17 for suitably enclosing the passage 17 of the container 10, and also for stably confining or retaining the pivot axle 18 within the passage 17 of the container 10.

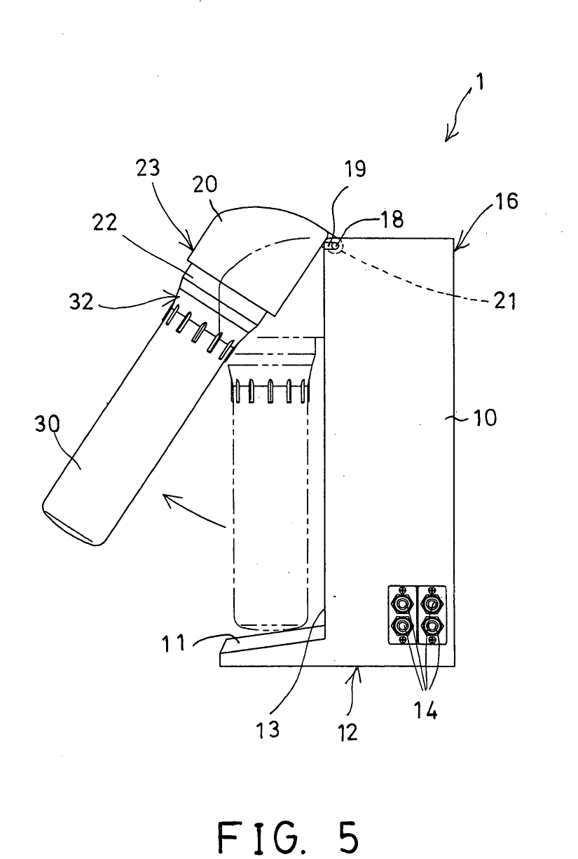

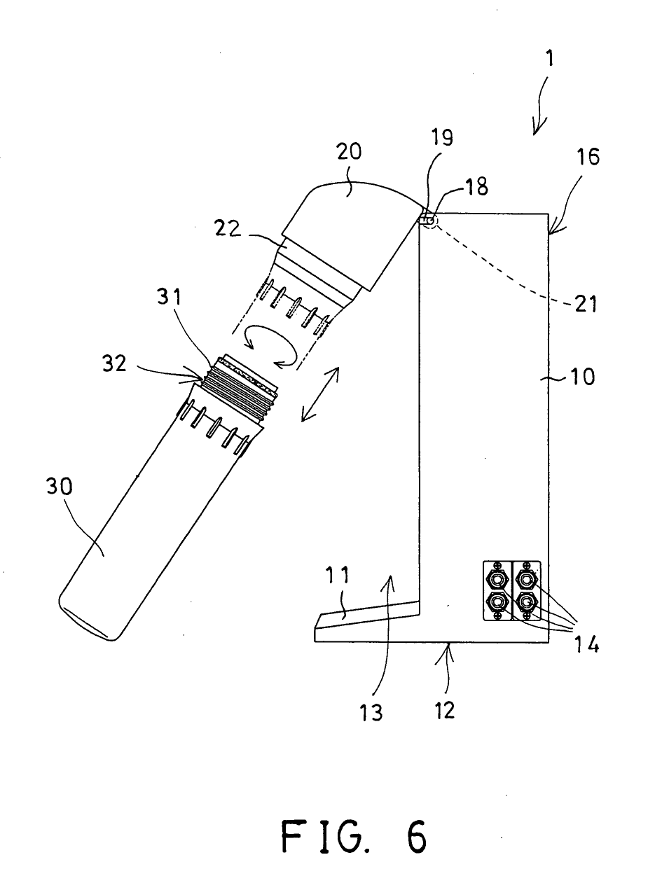

A casing or carrier 20 includes one or more ears 21 extended outwardly or rearwardly therefrom for engaging into the corresponding notches 15 of the container 10, and the pivot axle 18 is engaged into the notches 15 of the container 10 and engaged through the ears 21 of the carrier 20 (FIG. 4) for pivotally or rotatably attaching or coupling the carrier 20 to the container 10 and thus for allowing the carrier 20 to be rotated or moved toward and away from the container 10 (FIGS. 5, 6). The carrier 20 further includes one or more coupling mouths or sockets 22 provided or attached to the lower or bottom portion 23 thereof each for coupling or for attaching a canister or cartridge 30 to the carrier 20. The cartridge 30 and/or the carrier 20 will be coupled to the container 10 with such as manifolds (not shown) which is also not related to the present invention and will not be described in further details.

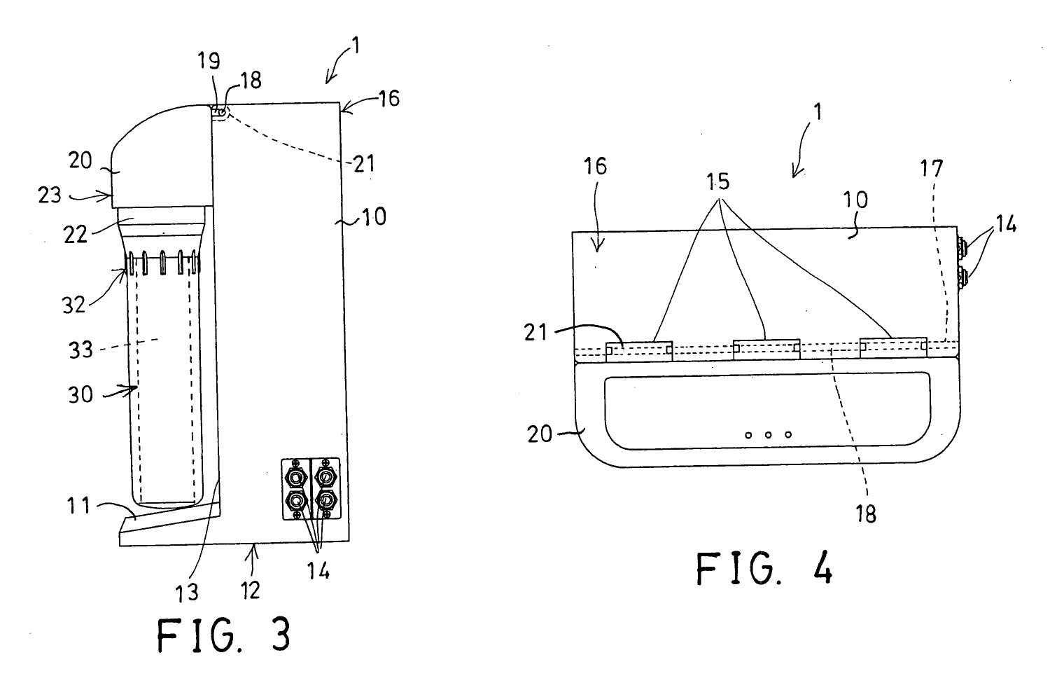

As shown in FIG. 6, the cartridges 30 each include an outer thread or a threaded coupling 31 formed or provided on the upper portion 32 thereof for threading or engaging with the corresponding sockets 22 of the carrier 20 and thus for detachably attaching or coupling the cartridges 30 to the sockets 22 of the carrier 20 respectively. The cartridges 30 may also be provided for receiving or carrying or supporting a filter member 33 therein (FIG. 3), such as a preliminary filter member, an active carbon filter member, an impurity filter member, a sediment filter member, a reverse osmosis filter member, an ultrafiltration filter member, or the like.

In operation, as shown in FIGS. 5 and 6, when it is required to attach or couple one or more of the cartridges 30 to the carrier 20, or required to detach or disengage one or more of the cartridges 30 from the carrier 20, the carrier 20 may be rotated or pivoted relative to the container 10 with the pivot axle 18 for allowing the carrier 20 and thus the cartridges 30 to be moved away from the container 10, and thus for allowing the cartridges 30 to be easily held and grasped by the user and to be easily rotated relative to the sockets 22 of the carrier 20, and thus to allow the filter members 33 to be easily and quickly engaged into or disengaged from the cartridges 30 or to be easily and quickly changed or replaced with the other new filter members.

Accordingly, the filter device in accordance with the present invention includes a structure for allowing the filter members to be changed or replaced with the new filter members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A filter device comprising:
a container including an upper portion and a lower portion,
a carrier pivotally attached to said upper portion of said container for allowing said carrier to be rotated and moved toward and away from said container, said carrier including at least one socket provided thereon, and
at least one cartridge detachably coupled to said at least one socket of said carrier for detachably coupling said at least one cartridge to said carrier.

2. The filter device as claimed in claim 1, wherein said at least one cartridge includes a threaded coupling provided thereon for coupling to said at least one socket of said carrier.

3. The filter device as claimed in claim 1, wherein said at least one cartridge includes a filter member disposed therein.

4. The filter device as claimed in claim 1, wherein said carrier is pivotally attached to said upper portion of said container with a pivot axle.

5. The filter device as claimed in claim 4, wherein said container includes at least one notch formed in said upper portion thereof, and said carrier includes at least one ear extended therefrom and engaged into said at least one notch of said container, and said pivot axle is engaged into said at least one notch of said container and engaged through said at least one ear of said carrier for pivotally coupling said carrier to said container.

6. The filter device as claimed in claim 4, wherein said container includes a passage formed therein and communicating with said at least one notch of said container for receiving said pivot axle in said passage of said container.

7. The filter device as claimed in claim 6, wherein said container includes at least one end caps engaged into one end portion of said passage for enclosing said passage of said container and for retaining said pivot axle within said passage of said container.

8. The filter device as claimed in claim 1, wherein said container includes a platform extended from said lower portion of said container for forming an open space above said platform and between said platform and said container and for forming a stable base structure to said container.
